(19) United States
(12) Patent Application Publication
(10) Pub. No.: US 2025/0329847 A1
(43) Pub. Date: Oct. 23, 2025

(54) Energy Storage System, Control Method, Apparatus, Electronic Device and Storage Medium

(71) Applicants: Peng Liu, Nanjing City (CN); Sicheng Liu, Nanjing City (CN)

(72) Inventor: Peng Liu, Nanjing City (CN)

(73) Assignees: Peng Liu, Nanjing City, JS (CN); Sicheng Liu, Nanjing City, JS (CN)

(21) Appl. No.: 18/891,402

(22) Filed: Sep. 20, 2024

(30) Foreign Application Priority Data
Apr. 22, 2024 (CN) 2024104825399

(51) Int. Cl. H01M 50/244; B25J 19/00; H01M 10/48; H01M 50/209; H01M 50/289; H01M 50/51

(52) U.S. Cl. CPC H01M 50/244; B25J 19/005; H01M 10/482; H01M 10/486; H01M 50/209; H01M 50/289; H01M 50/51

(57) ABSTRACT

An energy storage system, a control method, an apparatus, an electronic device and a storage medium are provided. The energy storage system includes a plurality of battery cell compartments which are electrically connected. An inner cavity of each of the battery cell compartments is adapted to a single battery cell. Each of the battery cell compartments is provided with a battery access channel exposed to an operable side. Each of the battery cell compartments provides series electrical connection between the battery cell located in the battery cell compartment and corresponding battery cell compartment, so as to form electrical connection between a plurality of battery cells located in the battery cell compartment. When a battery cell needs to be replaced, the battery cell only needs to be taken out and replaced with a new battery cell, which improves the replacement speed and reduces the space required for maintenance.

### CROSS-REFERENCE TO RELATED APPLICATION

This patent application claims the benefit and priority of Chinese Patent Application No. 2024104825399, filed with the China National Intellectual Property Administration on Apr. 22, 2024, the disclosure of which is incorporated by reference herein in its entirety as part of the present application.

### TECHNICAL FIELD

The present disclosure relates to an energy storage system, in particular to an energy storage system and a control method thereof.

### BACKGROUND

An energy storage container is an integrated energy storage device. Various energy storage technologies are combined with intelligent control systems to efficiently store and release energy. The energy storage container can not only provide emergency power support, but also balance the power grid load, regulate the peak load and fill the valley load, and improve the utilization rate of renewable resources, etc., which has great significance to the stability and sustainable development of energy demand.

The existing energy storage container is configured as follows: a plurality of battery cells bound in series to form a battery cell module, two or three battery cell modules connected in series are installed in a battery cell pack with single-positive-electrode and single-negative-electrode connection points built therein; all battery cell modules in a battery cell pack form a circuit connection with other battery cell packs through the single positive electrode and the single negative electrode; a plurality of battery cell packs are connected in series to form a battery cell cluster, and a plurality of battery cell clusters are connected in series or in parallel to form a battery cell system of the energy storage container.

For several battery cells connected in series, due to buckets effect, manufacturers will choose battery cells with similar health status to be connected in series as a whole when the battery cells leave the factory. However, after a period of use or a certain number of times of charging and discharging, the health status of a group of battery cells with similar original performance changes differently, and even the performance of the whole series branch is restricted by the rapid deterioration of individual battery cells.

Once forgoing circumstance happens, the existing energy storage container structure will cause the whole battery cell pack to be unable to be used normally. As a battery cell cluster contains multiple battery cell packs, there is a high probability that the battery cells in one battery cell cluster are damaged or deteriorated seriously. As such, it is necessary to replace the whole battery cell pack containing the battery cells which are damaged or deteriorated seriously to continue to use the energy storage container normally. As the whole battery cell pack is bulky and heavy, the hoisting device involved in replacement is bulky, so that when arranging the energy storage container, space needs to be reserved around the energy storage container to accommodate the larger hoisting device. The replacement process needs manual participation, the maintenance pressure is high, and it is usually impossible to carry out replacement in time. Moreover, the whole energy storage container must be shut down from a safety perspective due to the disconnection of the series circuit of the battery cell clusters during the replacement process, which is not conducive to the energy density and continuous work of the energy storage container. On the other hand, due to replacing the whole battery cell pack, many other battery cells with acceptable performance in the battery cell pack cannot continue to serve, resulting in a waste of resources.

### SUMMARY

The embodiment of the present disclosure provides an energy storage system, a control method, an apparatus, an electronic device and a storage medium, to replace the battery cell conveniently in the energy storage system and prolong the service life of the battery cell and the whole energy storage system.

In a first aspect of the present disclosure, an energy storage system is provided, including:
a plurality of battery cell compartments which are electrically connected, where an inner cavity of each of the battery cell compartments is adapted to a single battery cell;
each of the battery cell compartments is provided with a battery access channel exposed to an operable side, so that the battery cell can be taken out of or be put into the battery cell compartment through a corresponding access channel;
each of the battery cell compartments provides series electrical connection between corresponding battery cell located in the battery cell compartment and the battery cell compartment, so as to form electrical connection between a plurality of battery cells located in the battery cell compartments.

In an embodiment, the access channel of each of the battery cell compartments is exposed to interconnected operable sides.

In an embodiment, the energy storage system further includes a robot, where the robot is arranged at the operable side of the battery cell compartment, and the robot takes the battery cell out of the corresponding battery cell compartment after receiving a taking-out task of the battery cell or puts the battery cell into the corresponding battery cell compartment after receiving a putting-into task of the battery cell, so as to allow the battery cell access to or from the battery cell compartment where the battery cell is located.

In an embodiment, a plurality of battery cell compartments are connected in series to form a battery cell compartment cluster, a plurality of battery cell compartment clusters are connected in parallel, and the battery cell compartment clusters are arranged sequentially.

In an embodiment, at least one of the battery cell compartments is provided with a sensor to detect at least one of an environment in corresponding battery cell compartment and performance of corresponding battery cell, and the environment or performance includes at least one of: temperature, voltage, current and internal resistance.

In an embodiment, the operable side is provided with a backup battery area in which a plurality of unused battery cells are stored.

In an embodiment, each of the battery cell compartments is provided with a bypass line, and after the battery cell compartment is disconnected from a series electrical connection with corresponding battery cell therein, the bypass line is connected between the series electrical connection points to form short-circuit.

In a second aspect of the embodiment of the present disclosure, a control method of an energy storage system is provided, which is applied to the energy storage system in the above embodiment, where the control method includes: in response to a first battery cell meeting a first exit condition, taking the first battery cell out of a first battery cell compartment where the first battery cell is located, and putting a second battery cell into the first battery cell compartment; where the first exit condition is that the performance of the first battery cell is inferior to that of other battery cells in a series branch where the first battery cell compartment is located, and the performance of the second battery cell is closer to that of other battery cells in the series branch where the first battery cell compartment is located than the performance of the first battery cell.

In an embodiment, prior to putting the second battery cell into the first battery cell compartment, the method includes:

taking the second battery cell out of a second battery cell compartment where the second battery cell is located or using an unused battery cell as the second battery cell; where the series branch where the second battery cell compartment is located is different from the series branch where the first battery cell compartment is located; the condition of using the unused battery cell as the second battery cell is that the first battery cell is located in the series branch with a best performance and there are no qualified second battery cells in other series branches.

In an embodiment, after taking the first battery cell out of the first battery cell compartment where the first battery cell is located, the method includes:

putting the first battery cell into a third battery cell compartment, where the performance of the first battery cell is closer to that of other battery cells in the series branch where the third battery cell compartment is located than the performance of the third battery cell stored originally in the third battery cell compartment.

In an embodiment, before the first battery cell meets the first exit condition, the method includes:
connecting a plurality of battery cell compartments in series to form battery cell compartment clusters, connecting the plurality of battery cell compartment clusters in parallel and arranging the battery cell compartment clusters sequentially to form a battery cell wall;
measuring the performance of each of the battery cells and sorting all battery cells in descending order of performance.
putting the battery cells into the battery cell walls one by one along a single direction of parallel connection of the battery cell walls according to a sorting order.

In a third aspect of the present disclosure, a control apparatus of an energy storage system is provided, which is applied to the energy storage system in the above embodiment, including:

a first battery cell replacing unit, configured to, in response to a first battery cell meeting a first exit condition, take the first battery cell out of a first battery cell compartment where the first battery cell is located, and put a second battery cell into the first battery cell compartment; where the first exit condition is that the performance of the first battery cell is inferior to that of other battery cells in a series branch where the first battery cell compartment is located, and the performance of the second battery cell is closer to that of other battery cells in the series branch where the first battery cell compartment is located than the performance of the first battery cell.

In a fourth aspect of the present disclosure, an electronic device is provided, including a memory, a processor and a computer program stored in the memory and executable on the processor, where the processor, when executing the computer program, causes the electronic device to implement the method described in any one of the above embodiments.

In a fifth aspect of the present disclosure, a non-transitory computer-readable storage medium is provided, which is used to store a computer program, where the computer program, when operated on a computer, causes the computer to execute the method described in any one of the above embodiments.

In a sixth aspect of the present disclosure, a computer program product is provided, where the computer program product, when operated on an electronic device, causes the electronic device to execute the control method described in any one of the above embodiments.

According to the energy storage system, the control method, the apparatus, the electronic device and the storage medium provided by the embodiment of the present disclosure, each of the battery cells is provided with a battery cell compartment, the battery cell compartment is electrically connected with the battery cell, and the battery cell compartments are electrically connected with each other, so that the battery cells are electrically connected for energy storage. When a battery cell in the energy storage system needs to be replaced, it is only necessary to take the battery cell out of the battery cell compartment and replace the battery cell with a new battery cell. As the battery cell is light and small in size, a replacement speed can be shortened, the space required for replacement and maintenance can be reduced, and even the battery cell can be automatically replaced by robots without manual participation.

According to the embodiment of the present disclosure, based on the above structure, during the operation of the energy storage system, the battery cells with closer performance in the energy storage system are put into the same series branch in real time with the deterioration of battery cells, which enables each of the battery cells in the series branch, the whole series branch and even the whole energy storage system to be more efficient. Through the above mode, the precise management of the battery cells can be achieved, and the battery cells may be discarded after being exhausted, thereby greatly improving the utilization rate of each of the battery cells, and thus prolonging the service life of the whole energy storage system.

### BRIEF DESCRIPTION OF THE DRAWINGS

The accompanying drawings, which constitute a part of the present disclosure, are used to provide a further understanding of the present disclosure. The illustrative embodiments of the present disclosure and the descriptions thereof are used to explain the present disclosure, and do not constitute an improper limitation of the present disclosure. In the accompanying drawings:

FIG. 1 is a schematic diagram of an overall structure of a battery cell compartment according to an embodiment of the present disclosure.

FIG. 2 is a schematic diagram of a cross-sectional structure of a battery cell compartment according to an embodiment of the present disclosure.

FIG. 3 is a schematic structural diagram of a battery cell wall and a robot according to an embodiment of the present disclosure.

FIG. 4 is a schematic structural diagram of an interior of an energy storage container according to an embodiment of the present disclosure.

FIG. 5 is a flowchart of a control method of an energy storage system according to an embodiment of the present disclosure.

FIG. 6 is a schematic structural diagram of a control apparatus of an energy storage system according to an embodiment of the present disclosure.

FIG. 7 is a schematic diagram of a hardware composition structure of an electronic device according to an embodiment of the present disclosure.

In the figures, each of the reference signs is as follows:
1—compartment body; 2—compartment door; 11—compression part; 12—first conductive member; 13—spring; 14—base part; 15—cooling plate; 16—rear cavity; 17—bottom plate; 18—second conductive member; 21—pressing door lock; 3—battery cell wall; 4—clamping jaw; 5—transverse guide rail; 6—vertical guide rail; 7—new battery cell bank; 8—damaged battery cell bank; 100—robot; 200—energy storage container.

### DETAILED DESCRIPTION OF THE EMBODIMENTS

It should be noted that the embodiments in the present disclosure and the features in the embodiments can be combined with each other without conflict. The present disclosure will be described in detail with reference to the attached drawings and embodiments.

In the description of the present disclosure, it should be noted that the orientational or positional relationships indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, etc. are based on the orientational or positional relationships shown in the drawings only for the convenience of describing the present disclosure and simplifying the description, rather than indicate or imply that the referred devices or elements must have a specific orientation, be constructed and operated in a specific orientation, and therefore should not be construed as limiting the present disclosure. In addition, the terms such as “first” and “second” are only used for the purpose of description, and cannot be understood as indicating or implying relative importance or implicitly indicating the number of indicated technical features. Therefore, the features defined as “first” and “second” may explicitly or implicitly include one or more of the features. In the description of the present disclosure, “a plurality of” means two or more, unless otherwise specifically defined.

In the description of the present disclosure, it should also be noted that unless otherwise specified and defined expressly, the terms such as “mount”, “link” and “connect” should be understood broadly, for example, it can be fixed connection, detachable connection or integral connection; or mechanical connection or electrical connection or communication with each other; or direct connection or indirect connection through an intermediate medium, or internal communication of two elements or the interaction between two elements. For those skilled in the art, the specific meanings of the above terms in the present disclosure can be understood according to specific situations.

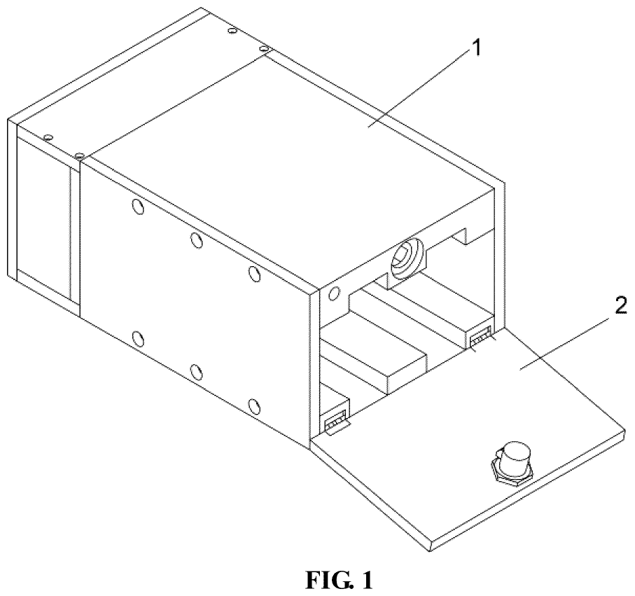

FIG. 1 is a schematic structural diagram of a battery cell compartment according to an embodiment of the present disclosure. As shown in FIG. 1, the battery cell compartment includes a plurality of outer walls, which enclose a hollow inner cavity adapted to a single battery cell.

The battery cell compartment provides a battery access channel exposed to an operable side, so that the battery cell accesses to or from the battery cell compartment through a corresponding access channel. In FIG. 1, the inner cavity is provided with an opening, so that the inner cavity is communicated with the outside. The inner cavity also serves as the battery access channel.

The battery cell compartment is provided with an electrical connection point for connecting the battery cell compartment to a circuit. A series electrical connection between the battery cells located in the battery cell compartment and the corresponding battery cell compartment is formed through the electrical connection point so that the battery cell can be connected to the circuit.

Through the battery cell compartment structure, the battery cells can easily access to or from the battery cell compartment. Moreover, an electrical connection between the battery cells may be achieved by the electrical connection between the battery cell compartment and the battery cell and an electrical connection between the battery cell compartments. Therefore, with the cooperation of the battery cell compartments and the battery cells, the operation of quick replacement of a single battery cell can be realized since the battery cell is small in size and light in weight. In some embodiments, the battery cell can be grabbed into and out of the battery cell compartment by controlling the clamping jaw 4 by the robot 100 to replace the battery cell.

The battery cell may be a lithium-ion battery cell, a sodium-ion battery cell, a sodium-lithium-ion battery cell, a lithium-metal battery cell, a sodium-metal battery cell, a lithium-sulfur battery cell, a magnesium-ion battery cell, a nickel-hydrogen battery cell, a nickel-cadmium battery cell, a lead-acid battery cell, etc., and the embodiment of the present disclosure is not limited thereto.

The battery cell generally includes an electrode assembly. The electrode assembly includes a positive plate, a negative plate and a separator. During the charging and discharging process of the battery cell, active ions (such as lithium ions) go back and forth between the positive plate and the negative plate and are inserted into and extracted from the positive plate or the negative plate. The separator is arranged between the positive plate and the negative plate, which can prevent a short circuit between the positive plate and the negative plate and allow active ions to pass therethrough.

As an example, the battery cell can be a prismatic battery cell, a pouchbattery cell or a battery cell with other shapes. The prismatic battery cell includes a square shell battery cell, a blade-shaped battery cell and a polygonal-prismatic battery cell. The polygonal-prismatic battery cell is, for example, a hexagonal prismatic battery cell, etc., which is not particularly limited in the present disclosure.

As shown in FIG. 1, in the embodiment of the present disclosure, an overall shape of the battery cell compartment is long and straight as a whole, which is adapted to a battery cell with an approximate cuboid shape. The battery cell is provided with positive and negative electrodes, and the inner cavity wall of the battery cell is provided with a plurality of grooves along the depth direction of the inner cavity for movement of the clamping jaw 4 that grasps the battery cell.

In order to fix the battery cells in the battery cell compartment, the battery cell compartment is provided with a position-limiting structure. In some embodiments, the battery cell compartment is provided with a compartment door 2 to expose or close the inner cavity with respect to the operable side. When the inner cavity is exposed with respect to the operable side, the battery cell can be moved from the outside of the battery cell compartment to the inside of the battery cell compartment or from the inside of the battery cell compartment to the outside of the battery cell compartment through the battery access channel. When the inner cavity is closed with respect to the operable side, the battery cell cannot access to or from the battery cell compartment.

When the compartment door 2 is closed, the battery cell is fixed in the inner cavity of the battery cell compartment and is connected with the electrical connection point, and when the compartment door 2 is open, the electrical connection between the battery cell and battery cell compartment is disconnected. Through the switching of the above different electrical connection modes, the battery cell can be connected to and removed from the circuit during the moving process.

As the battery cell and the battery cell compartment are connected in series, an open circuit will be formed at the battery cell compartment after the battery cell is disconnected from the battery cell compartment. Therefore, in some embodiments, the battery cell compartment further provides a bypass line. When the battery cell needs to be disconnected from the battery cell compartment, it is preferable to form a short-circuit between series electrical connection points by the bypass line before the series electrical connection between the battery cell compartment and the battery cell is disconnected. In this way, after the battery cell is disconnected from the battery cell compartment, the series branch where the battery cell compartment is located still remains connected.

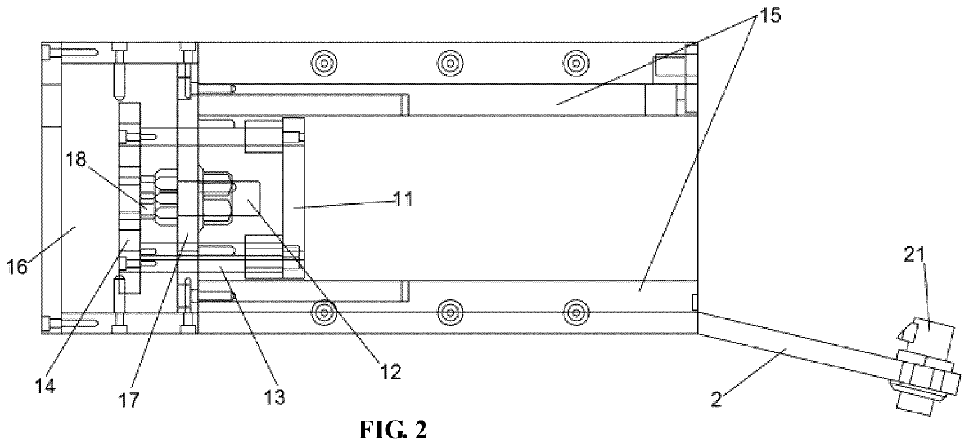

In some embodiments, as shown in FIGS. 1 and 2, the compartment door 2 is in the form of a flip type. The compartment door 2 is locked with the battery cell compartment by a pressing door lock 21.

In some embodiments, the battery cell compartment is provided with a cooling plate 15. The cooling plate 15 is used to cool and radiate the battery cells. The cooling plate 15 can uses a water cooling mode. A cooling water pipe is built in the cooling plate 15.

In some embodiments, as shown in FIG. 2, the battery cell compartment includes a compartment body 1 with an openable inner cavity and a bottom plate 17 fixed at the bottom of the inner cavity

A first conductive member 12 is fixed at one side of the bottom plate 17 toward the inner cavity as an electrical connection point connecting with two electrodes of the battery cell. A second conductive member 18 is fixed at the other side of the bottom plate 17. The second conductive member 18 is electrically connected with the first conductive member 12 in series.

The battery cell compartment further includes a slide assembly. The slide assembly further includes a compression part 11, a connecting part and a base part 14. The compression part 11 and the base part 14 are located at two sides of the bottom plate 17, respectively. The compression part 11 is located at one side of the inner cavity. The connecting part passes through the bottom plate 17 and connects the compression part 11 and the base part 14, so that the first conductive member 12 and the second conductive member 18 are accommodated between the compression part 11 and the base part 14. The compression part 11 provides a first through hole adapted to the electrode of the battery cell, so that when the electrode end of the battery cell is pressed against the compression part 11, the electrode of the battery cell passes through the first through hole to the area where the first conductive member 12 is located.

A pre-compressed spring 13 is provided between the compression part 11 and the bottom plate 17. The connecting part is preferably in a columnar structure. The spring 13 is sleeved on the connecting part. The base part 14 is further provided with a short wire adapted to the second conductive part 18 as a bypass line. The bypass line contacts and short-circuits the second conductive part 18 when the base part 14 moves to a side of the bottom plate 17.

In some specific embodiments, the first conductive member 12 and the second conductive member 18 both include two columns corresponding to the positive electrode and the negative electrode, respectively. A one-to-one correspondence electrical connection is further formed between the columns of the first conductive member 12 and the second conductive member 18.

With the above structure, when the battery cell is put into the battery cell compartment, the side where the electrode of the battery cell is located is oriented towards the bottom plate 17, and the battery cell moves from the open side of the compartment body 1 to the side of the bottom plate 17. The battery cell is first in contact with the compression part 11, and the electrode of the battery cell is exposed to the area where the first conductive piece 12 is located. However, when the battery cell is just in contact with the compression part 11, the electrode of the battery cell has not yet been in contact with the first conductive member 12, and the battery cell continues to move toward the bottom plate 17 of the battery cell compartment against the compression part 11. In this process, the whole sliding assembly moves synchronously, and then the electrode of the battery cell moves to contact with the first conductive member 12, so that the battery cell is in series connection with the battery cell compartment

When the battery cell is taken out of the battery cell compartment, the compartment door 2 is opened, so that the limit of the compartment door 2 on the battery cell disappears, and the battery cell moves towards the open side of the compartment body 1, so that the electrode of the battery cell is disconnected from the first conductive member 12. During this process, due to the pre-compressed spring 13, the sliding assembly will move initially along with the movement direction of the battery cell, so that the sliding assembly returns to its original position. During the return of the sliding assembly, the base part 14 located at one side of the second conductive member 18 approaches to the one side of the second conductive member 18 synchronously, so that the short wire located on the base is overlapped on the second conductive member 18 to realize a short circuit.

In some preferred embodiments, the compartment door 2 is provided with an clastic switch. As the compartment door 2 retreats toward outside of the battery cell compartment when being closed, a spring 13 is connected between the first conductive member 12 and the bottom plate 17 in order to make the compartment door 2 cooperate with the inner cavity to achieve a good limit on the battery cell. When the battery cell is in contact with the first conductive member 12 when moving into the compartment, the spring 13 is compressed and shortened. After the compartment door 2 is closed and retreats, the spring 13 rebounds a certain distance so that the first conductive member 12 is always connected with the electrode.

In some preferred embodiments, in order to prevent the battery from expanding due to a high internal pressure, second through holes are provided in the compression part 11 and the bottom plate 17, or the compression part 11, the bottom plate 17 and the base part 14. The second through holes are opposite to the end faces of the battery cell. Through the second through hole, the gas that may be released is discharged from the inner cavity, so as to reduce the pressure of the battery cell and the inner cavity.

As shown in FIG. 1, in some embodiments, the battery cell compartment further includes a housing, which is fixed on the compartment body 1 and is arranged outside the base part 14 so that the base part 14 is built-in. As shown in FIG. 1, the housing is located behind the inner cavity. A rear cavity 16 provided at the rear side of the inner cavity is formed between the housing and the bottom plate 17 of the inner cavity. The base part 14 is located in the cavity, which is beneficial to prevent the base part 14 from influence of dust, water vapor and the like.

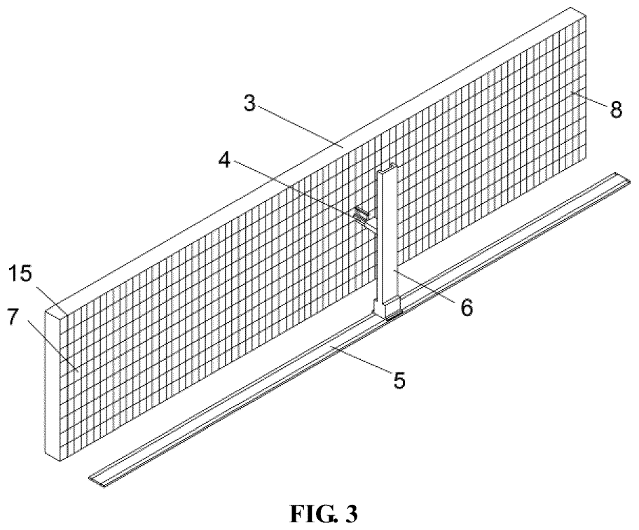

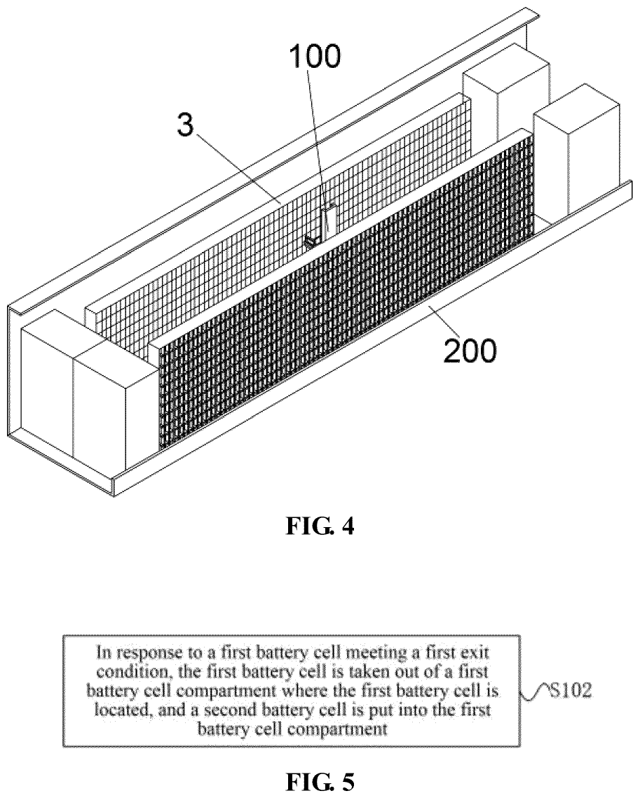

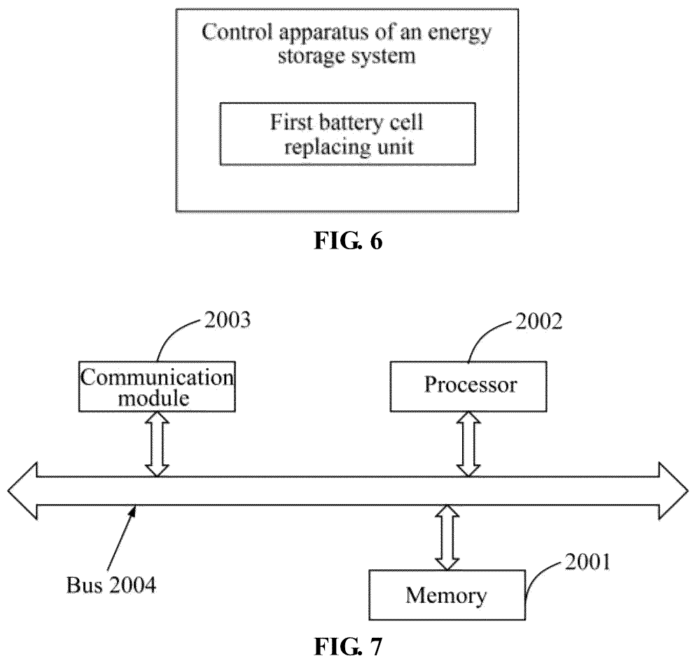

As shown in FIGS. 3 to 4, a schematic structural diagram of an energy storage system according to other embodiments of the present disclosure is provided. Power is supplied to an electrical equipment by the energy storage structure. The electrical equipment can be vehicles, mobile phones, portable devices, notebook computers, ships, spacecraft, electric toys and electric tools, etc., which is not specially limited in the embodiment of the present disclosure.

In FIGS. 3 to 4, the energy storage system includes:

a plurality of battery cell compartments which are electrically connected, where an inner cavity of each of the battery cell compartments is adapted to a single battery cell. Each of the battery cell compartments of the energy storage system may be the structure of the battery cell compartment in each embodiment.

Each of the battery cell compartments provides a battery access channel exposed to an operable side, so that the battery cell can access to or from the battery cell compartment through the corresponding access channel. That is, after each of the battery cell compartments is formed, its own battery access channel is still located at the operable side, so that the operation of taking out batteries of and putting batteries into each of the battery cell compartments will not be affected.

Each of the battery cell compartments provides series electrical connection between the battery cells located in the battery cell compartment and the corresponding battery cell compartment, so as to form electrical connection between a plurality of battery cells located in the battery cell compartment.

In the energy storage system formed by combining the battery cell compartments, when a battery cell in the energy storage system needs to be replaced, it is only necessary to take the battery cell out of the battery cell compartment and replace the battery cell with a new battery cell, which realizes the purpose that the battery cell can be quickly connected to and disconnected from the circuit. Since the battery cell is light in weight and small in size, the replacement speed can be improved, and the space required for maintenance can be reduced.

In order to facilitate taking operations of the battery cells in respective of the battery cell compartments into consideration simultaneously, in some embodiments, the access channel of each of the battery cell compartments is exposed to the interconnected operable sides. The operation of the target battery cell compartment can be realized by moving to the corresponding battery cell compartment position in the operable side area.

In some preferred embodiments, the energy storage system further includes a robot 100, where the robot 100 is arranged at the operable side of the battery cell compartment, and the robot 100 takes the battery cell out of/puts the battery cell into the corresponding battery cell compartment after receiving the task of taking out the battery cell/putting the battery cells in, so that the battery cell can access to or from the battery cell compartment where the battery cell is located.

As shown in FIG. 3 and FIG. 4, the battery cell wall 3 includes a plurality of battery cell compartments. In some embodiments, the battery cell wall 3 consists of a plurality of battery cell compartments. In these embodiments, the outside of the battery cell compartment is a relatively regular structure, such as a cuboid structure used in this embodiment, so that a plurality of battery cell compartments can be easily stacked and fixed to each other. The fixing structure among the battery cell compartments can be preferably detachable. As shown in FIGS. 3 to 4, a plurality of battery cell compartments are sequentially stacked in the vertical direction to form the battery cell wall 3 with a certain height. A plurality of battery cell compartments are also sequentially arranged in the horizontal direction to form the battery cell wall 3 with a certain width. Moreover, during arrangement, the inner cavity of each of the battery cell compartments is arranged along a plane perpendicular to the vertical direction and the horizontal direction mentioned above, and the openings of the inner cavities are located at the same side of the battery cell wall 3.

As a preferred embodiment, the battery cell wall 3 is further provided with a new battery cell bank 7 and a damaged battery cell bank 8, which may be battery cell compartments with the same shape as battery cell compartments in the battery cell wall 3 in the above embodiment. However, these battery cell compartments are, not connected to the circuit, and arranged integrally with the battery cell wall 3, and preferably arranged on both sides of the battery cell wall 3. The new battery cell bank 7 is arranged at one side of the battery cell wall 3, and the damaged battery cell bank 8 is arranged at the other side of the battery cell wall 3.

Specifically, as shown in FIG. 3, a schematic structural diagram of a battery cell wall 3 is provided. A robot 100 is arranged at the opening side of the inner cavity of the battery cell compartment in the battery cell wall 3. A transverse guide rail 5 in parallel with the battery cell wall 3 is arranged at the bottom of the robot 100. A motor driving the automated robot 100 to move along the transverse guide rail 5 is defined as an X-axis motor. The robot 100 includes a vertical guide rail 6 and a mechanical clamp moving along the vertical guide rail 6. The motor driving the mechanical clamp to move along the vertical guide rail 6 is defined as a Z-axis motor. The mechanical clamp includes a clamping jaw 4 that stretches back and forth. A motor driving the clamping jaw 4 to stretch back and forth is defined as a Y-axis motor. The X-axis motor, the Y-axis motor and the Z-axis motor are in communication with a Programmable Logic Controller (PLC) control system and receive driving signals sent from the PLC control system.

For the convenience of calculation, the first battery cell in the lower left corner of the battery cell wall 3 can be set as the coordinate origin. The length direction of the battery cell wall 3 is the X-axis positive direction, and the height direction of the battery cell wall 3 is the Y-axis positive direction. Each battery cell in the battery cell wall 3 has unique X-axis and Y-axis coordinates. The coordinate information of each of the battery cells is input into the PLC control system in advance. When a battery cell needs to be replaced, the PLC control system sends driving signals of the X-axis motor, the Y-axis motor and the Z-axis motor that control the clamping jaw 4 to move to the coordinate position of corresponding battery cell. By controlling the ON/OFF of the X-axis motor, the Y-axis motor and the Z-axis motor, the displacement of the clamping jaw 4 can be accurately controlled. After the clamping jaw 4 moves to the corresponding position, the battery cell is taken out of the battery cell wall 33 and replaced with a new battery cell.

In some embodiments, the robot 100 performs the operations according to the following steps: acquiring the coordinate information of the position where the battery cell to be taken out is located, and transmitting the coordinate information of the position to the PLC control system. The PLC control system controls the ON/OFF of the X-axis motor, the Y-axis motor and the Z-axis motor according to the received coordinate information, so as to move the clamping jaw 4 to a designated position, thereby opening the battery cell compartment door 2 (which can be controlled by the system or operated by the robot 100 to be opened). Then the clamping jaw 4 extends into the compartment body 1, grips the battery cell, and exits from the battery cell compartment carrying the battery cell. If the battery cell needs to be loaded in a new battery cell compartment, the robot 100 drives the battery cell to move to the position of the new battery cell compartment, and puts the battery cell into the new battery cell compartment. Thereafter, the clamping jaw 4 exits, and the compartment door 2 of the new battery cell compartment is closed (which can be controlled by the system or operated by the robot 100 to be closed). If the battery cell can no longer be used, the battery cell is grabbed to a battery recycling area, such as the damaged battery cell bank 8 in the above embodiment, and without participating in energy storage any longer.

In other embodiments, referring to the schematic structural diagram of the energy storage container 200 shown in FIG. 4, a single energy storage container 200 includes two battery cell walls 3. The sides, of the two battery cell walls 3, where the battery cells are installed are opposite to each other. The robot 100 is arranged between the two battery cell walls 3. The robot 100 is provided with a steering mechanism to control the steering of the clamping jaw 4. The clamping jaw 4 on the automatic robot 100 rotates through the steering mechanism, and simultaneously, takes out and replaces the battery cells on the two battery cell walls 3. The two battery cell walls 3 increase the number of battery cells, and the electric energy volume of the energy storage container 200 is greatly increased with only one robot 100 being needed, which saves the floor space and ensures the energy storage density.

Besides the energy storage container 200, this embodiment can be further applied to other forms of energy storage systems, such as energy storage cabinets.

In other embodiments, more battery cell walls 3 can be further provided. A path through which the robot 100 walks can be established between the battery cell walls 3. The path may be realized by rails, such as the rails arranged on the bottom plate 17 of the energy storage container 200 as shown in the above embodiments, or the rails arranged in the air, or the rails arranged on the top plate of the container. The path may be further realized without rails, for example, by using the trackless robot 100 that can move freely.

In these embodiments, in order to manage and operate the battery cells and even the whole battery cell wall 3 more scientifically and efficiently, a plurality of battery cell compartments are connected in series to form battery cell compartment cluster, and a plurality of battery cell compartment clusters are connected in parallel, and arranged sequentially. In this way, according to buckets effect of the series connection of the battery, the performance of the battery cells belonging to the same battery cell compartment cluster should be as close as possible, so that the battery cell compartment cluster can exert its maximum efficiency.

In some embodiments, a sensor is arranged in at least one of the battery cell compartments to detect the environment in the battery cell compartments and/or the performance of the battery cells, and the environment or performance includes at least one of: temperature, voltage, current and internal resistance. The sensor can monitor the battery cell compartments and the battery cells accurately, which is beneficial to obtaining the operation situation of each of the battery cells and facilitates decision-making for managing the battery cell.

In some embodiments, the operable side is further provided with a backup battery area, in which a plurality of unused battery cells are stored. When the battery cells in the battery cell wall 3 are damaged due to various reasons, the battery cell wall 3 can be supplemented by the battery cells in the backup battery area.

In some preferred embodiments, each of the battery cell compartments further provides a bypass line, and after the series electrical connection between the battery cell compartment and the battery cells therein is disconnected, the bypass line is connected between the series electrical connection points for short-circuit. The specific implementation of the bypass line may be the structure in the embodiment of the battery cell compartment. Whether a short-circuit is formed by the bypass line or not may be automatically switched through the movement of the battery cell, which needs no additional control system.

Embodiments of the present disclosure further provide a control method of an energy storage system, which is applied to the energy storage system in the above embodiments, and the method includes:

Step S102, in response to a first battery cell meeting a first exit condition, taking the first battery cell out of a first battery cell compartment where the first battery cell is located, and putting a second battery cell into the first battery cell compartment; where the first exit condition is that the performance of the first battery cell is inferior to that of other battery cells in a series branch where the first battery cell compartment is located, and the performance of the second battery cell is closer to that of other battery cells in the series branch where the first battery cell compartment is located than the performance of the first battery cell.

When the energy storage system is just put into use, the performance of each of the battery cells are almost the same and the performance of each series branch are almost the same. During the use of the energy storage system, the above method is implemented. By setting the first exit condition, it is determined whether the battery cell meets the condition to decide whether the battery cell needs to be removed from the battery cell compartment, and to replace a new battery cell more suitable for the battery cell compartment, so as to manage the battery cell and the battery cell compartment. When the method is applied to the whole energy storage system, the purpose of individually replacing the battery cells during the use of the entire energy storage system can be realized, which is convenient and efficient. The performance of the battery cells in the series branch is closer through replacement, so that the whole series branch is more efficient. The above scheme is implemented for each series branch in the whole energy storage system, which can ensure that each series branch can maximize its efficiency, thus ultimately maximizing the overall efficiency of the whole energy storage system.

The performance includes, but is not limited to, the internal resistance, life and capacity of the battery.

As a battery to replace the first battery cell, the second battery cell has a source depending on different situations. Therefore, in some preferred embodiments, prior to putting the second battery cell into the first battery cell compartment, the method further includes:

Step S101: taking the second battery cell out of the second battery cell compartment where the second battery cell is located or using an unused battery cell as the second battery cell; where the series branch where the second battery cell compartment is located is different from the series branch where the first battery cell compartment is located; the condition of using an unused battery cell as the second battery cell is that the first battery cell is located in the series branch with the best performance and there are no qualified second battery cells in other series branches. That is, in this embodiment, the battery cells that have been put into use in the battery cell wall 3 are preferentially selected as replacements. Only when there is no suitable battery cell in the battery cell wall 3, an unused battery cell is selected as the second battery cell, for example, from the new battery cell bank 7 in the above embodiment. More preferably, in some embodiments, especially when replacement requirement occurs in the series branch with the best performance, there will be no suitable battery cell as a replacement because the performance of other series branches is inferior to that of this branch. Therefore, it is necessary to use an unused battery cell as the replacement at this time.

In some preferred embodiments, since the first battery cell may not have reached an extent of being scrapped yet, and satisfy the first exit condition only on the current series branch, and may improve the performance of other series branches when used in the other series branches as a replacement, the first battery cell may be put into the other series branches as a replacement. Therefore, after taking the first battery cell out of a first battery cell compartment where the first battery cell is located, the method further includes:

Step S103: putting the first battery cell into a third battery cell compartment, where the performance of the first battery cell is closer to that of other battery cells in the series branch where the third battery cell compartment is located than the performance of the third battery cell stored originally in the third battery cell compartment.

On the basis of the above method, in order to facilitate the management and consider the better replacement path of battery cells, in some preferred embodiments, the method is implemented in such a manner that a plurality of battery cell compartment clusters, formed by a series connection between a plurality of battery cell compartments, are connected in parallel, and arranged sequentially to form battery cell walls 3 with a wall structure. The battery cell wall 3 is divided into different battery performance areas according to a certain preset order. For example, the battery cell wall 3 is divided from left to right with the battery cell compartment cluster as a basic unit. As the above method is executed, the basic units are arranged in a manner of decreasing or increasing performance.

In some specific embodiments, the method is still implemented in such a manner that the plurality of battery cell compartment clusters, formed by a series connection between a plurality of battery cell compartments, are connected in parallel, and arranged sequentially to form battery cell walls. Before the first battery cell meeting the first exit condition, the method further includes:
Step S1001: measuring the performance of each of the battery cells and sorting all battery cells in descending order of performance;
Step S1002: putting the battery cells into the battery cell walls one by one along a single direction of parallel connection of the battery cell walls according to the sorting order.

Through the above method, taking the performance decreasing from left to right as an example, the cluster with the best performance in the battery cells is on the leftmost side, then the cluster with the second best performance is next to the leftmost side, and then the cluster with the third best performance, the medium performance, the poor performance and finally the worst performance is on the rightmost side.

Through the above method, each of the battery cell compartments is located in the series branch adapted to its real-time performance. Under normal circumstances, with the gradual deterioration of its performance, once demand is satisfied, the battery cell compartments are taken out of the current series branch, and gradually go through different clusters from the good performance to the poor performance. After many adjustments, the battery cell compartments are finally taken out of the cluster with the worst performance so as to be out of use. For a battery cell, it is high in utilization rate and high in battery efficiency. For the whole energy storage system, if each battery is applied in a similar way, the service life of the energy storage system can be greatly improved.

Further, although the operations of the method of the present disclosure are described in a particular order in the drawings, it is not required or implied that these operations must be performed in this particular order, or that all the illustrated operations must be performed to achieve the desired results. Additionally or alternatively, some steps may be omitted, a plurality of steps may be combined into one step for execution, and/or one step may be decomposed into a plurality of steps for execution.

The embodiments of the present disclosure further provide a control apparatus of an energy storage system, which is applied to the energy storage system in the above embodiments, including:

a first battery cell replacing unit, configured to, in response to a first battery cell meeting a first exit condition, take the first battery cell out of a first battery cell compartment where the first battery cell is located, and put a second battery cell into the first battery cell compartment; where the first exit condition is that the performance of the first battery cell is inferior to that of other battery cells in a series branch where the first battery cell compartment is located, and the performance of the second battery cell is closer to that of other battery cells in the series branch where the first battery cell compartment is located than the performance of the first battery cell.

By setting the first exit condition, it is determined whether the battery cell meets the condition to decide whether the battery cell needs to be removed from the battery cell compartment, and to replace a new battery cell more suitable for the battery cell compartment, so as to manage the battery cell and the battery cell compartment. When the method is applied to the whole energy storage system, the purpose of individually replacing the battery cell during the use of the entire energy storage system can be realized, which is convenient and efficient. The performance of the battery cells in the series branch is closer through replacement, so that the whole series branch is more efficient. The above scheme is implemented for each series branch in the whole energy storage system, which can ensure that each series branch can maximize its efficiency, thus ultimately maximizing the overall efficiency of the whole energy storage system.

In some embodiments, the control apparatus further includes:

a second battery cell replacing unit, configured to put the first battery cell into a third battery cell compartment, where the performance of the first battery cell is closer to that of other battery cells in the series branch where the third battery cell compartment is located than the performance of the third battery cell stored originally in the third battery cell compartment.

In some embodiments, the control apparatus further includes:

a third battery cell replacing unit, configured to put the first battery cell into a third battery cell compartment, where the performance of the first battery cell is closer to that of other battery cells in the series branch where the third battery cell compartment is located than the performance of the third battery cell stored originally in the third battery cell compartment.

In some embodiments, the control apparatus further includes:
a measuring and sorting unit, configured to measure the performance of each of the battery cells and sort all battery cells in descending order of performance;
an order arranging unit, configured to put the battery cells into the battery cell walls one by one along a single direction of parallel connection of the battery cell walls according to the sorting order.

It should be noted that although several units or sub-units of the apparatus are mentioned in the above detailed description, such division is only exemplary and not mandatory. Actually, according to the embodiment of the present disclosure, the features and functions of two or more units described above can be embodied in one unit. On the contrary, the features and functions of one unit described above can be further divided into a plurality of units to be embodied.

Based on the same inventive concept as the above method embodiment, the embodiment of the present disclosure further provides an electronic device, including a memory, a processor and a computer program stored in the memory and executable on the processor, where the processor, when executing the computer program, causes the electronic device to implement the method in the above embodiment.

In one embodiment, the electronic device may be a server. In this embodiment, the structure of the electronic device may be as shown in FIG. 7, including a memory 2001, a communication module 2003 and one or more processors 2002.

The memory 2001 is configured to store computer programs executed by the processor 2002. The memory 2001 may mainly include a storage program area and a storage data area, where the storage program area can store an operating system, programs required for operating instant messaging functions, etc.; and the storage data area can store various instant messaging information and operating instruction sets.

The memory 2001 may be a volatile memory, such as a random access memory (RAM); the memory 2001 can also be a non-volatile memory, such as a read-only memory, a flash memory, a hard disk drive (HDD) or a solid state drive (SSD); alternatively, the memory 2001 is any other medium that can be used to carry or store a desired computer program in the form of instructions or data structures and can be accessed by a computer, but is not limited thereto. The memory 2001 may be a combination of the above memories.

The processor 2002 may include one or more central processing unit (CPU) or be a digital processing unit, etc. The processor 2002 is configured to implement the above-mentioned audio data processing method when calling the computer program stored in the memory 2001.

The communication module 2003 is configured to communicate with a terminal device and other servers.

The embodiment of the present disclosure does not limit the specific connection medium between the memory 2001, the communication module 2003 and the processor 2002 described above. In the embodiment of the present disclosure, the memory 2001 and the processor 2002 are connected through the bus 2004 in FIG. 7. The bus 2004 is described with thick lines in FIG. 7. The connection modes between other components are merely illustrative and are not intended to be limited thereto. The bus 2004 can be divided into an address bus, a data bus, a control bus, etc. For convenience of description, only one thick line is used in FIG. 7, which does not describe only one bus or one type of buses.

Based on the same inventive concept as the above method embodiment, the embodiment of the present disclosure further provides a computer-readable storage medium, wherein the computer-readable storage medium is used to store a computer program, which, when operating on a computer, causes the computer to execute the method in the above embodiment. The computer-readable storage medium may be a readable signal medium or a readable storage medium. The readable storage medium can be, for example, but not limited to, an electrical, magnetic, optical, electromagnetic, infrared, or semiconductor system, apparatus or device, or a combination thereof. More specific examples (a non-exhaustive list) of readable storage media include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

Based on the same inventive concept as the above method embodiment, the embodiment of the present disclosure further provides a computer program product, which includes a computer program, wherein the computer program product, when operating on an electronic device, causes the electronic device to execute the steps in the control method according to various exemplary embodiments of the present disclosure described above in this specification. The program product can use any combination of one or more readable media. These computer program commands may be provided to a processor of a general-purpose computer, a special-purpose computer, an embedded processor or other programmable data processing devices to produce a machine, so that the commands executed by the processor of the computer or other programmable data processing devices produce an apparatus for implementing the functions specified in one or more flows in the flowchart and/or one or more blocks in the block diagram.

Although the preferred embodiments of the present disclosure have been described, those skilled in the art can make additional changes and modifications to these embodiments once they know the basic inventive concepts. Therefore, the appended claims are intended to be interpreted as including the preferred embodiment and all changes and modifications that fall within the scope of the present disclosure.

1. An energy storage system, comprising:
a plurality of battery cell compartments which are electrically connected, wherein an inner cavity of each of the battery cell compartments is adapted to a single battery cell;
each of the battery cell compartments is provided with a battery access channel exposed to an operable side, so that the battery cell is taken out of or be put into the battery cell compartment through a corresponding access channel;
each of the battery cell compartments provides series electrical connection between corresponding battery cell located in the battery cell compartment and the battery cell compartment, so as to form electrical connection between a plurality of battery cells located in the battery cell compartments.

2. The energy storage system according to claim 1, wherein the access channel of each of the battery cell compartments is exposed to interconnected operable sides.

3. The energy storage system according to claim 2, further comprising a robot, wherein the robot is arranged at the operable side of the battery cell compartment, and the robot takes the battery cell out of the corresponding battery cell compartment after receiving a taking-out task of the battery cell or puts the battery cell into the corresponding battery cell compartment after receiving a putting-into task of the battery cell, so as to allow the battery cell access to or from the battery cell compartment where the battery cell is located.

4. The energy storage system according to claim 1, wherein a plurality of battery cell compartments are connected in series to form a battery cell compartment cluster, a plurality of battery cell compartment clusters are connected in parallel, and the battery cell compartment clusters are arranged sequentially.

5. The energy storage system according to claim 1, wherein at least one of the battery cell compartments is provided with a sensor to detect at least one of an environment in corresponding battery cell compartment and performance of corresponding battery cell, and the environment or performance comprises at least one of: temperature, voltage, current and internal resistance.

6. The energy storage system according to claim 1, wherein the operable side is provided with a backup battery area in which a plurality of unused battery cells are stored.

7. The energy storage system according to claim 1, wherein each of the battery cell compartments is provided with a bypass line, and after the battery cell compartment is disconnected from a series electrical connection with corresponding battery cell therein, the bypass line is connected between the series electrical connection points to form short-circuit.

8. A control method of an energy storage system, which is applied to the energy storage system according to claim 1, comprising:
in response to a first battery cell meeting a first exit condition, taking the first battery cell out of a first battery cell compartment where the first battery cell is located, and putting a second battery cell into the first battery cell compartment; wherein the first exit condition is that performance of the first battery cell is inferior to that of other battery cells in a series branch where the first battery cell compartment is located, and performance of the second battery cell is closer to that of other battery cells in the series branch where the first battery cell compartment is located than the performance of the first battery cell.

9. The method according to claim 8, wherein prior to putting the second battery cell into the first battery cell compartment, the method further comprises:
taking the second battery cell out of a second battery cell compartment where the second battery cell is located or using an unused battery cell as the second battery cell; wherein a series branch where the second battery cell compartment is located is different from the series branch where the first battery cell compartment is located; a condition of using the unused battery cell as the second battery cell is that the first battery cell is located in the series branch with best performance and there are no qualified second battery cells in other series branches.

10. The method according to claim 8, wherein after taking the first battery cell out of the first battery cell compartment where the first battery cell is located, the method comprises:
putting the first battery cell into a third battery cell compartment, wherein the performance of the first battery cell is closer to that of other battery cells in a series branch where the third battery cell compartment is located than performance of a third battery cell stored originally in the third battery cell compartment.

11. The method according to claim 8, wherein before the first battery cell meets the first exit condition, the method further comprises:
connecting a plurality of battery cell compartments in series to form battery cell compartment clusters, connecting the plurality of battery cell compartment clusters in parallel and arranging the battery cell compartment clusters sequentially to form a battery cell wall;
measuring the performance of each of the battery cells and sorting all battery cells in descending order of performance;
putting the battery cells into the battery cell walls one by one along a single direction of parallel connection of the battery cell walls according to a sorting order.

12. A control apparatus of an energy storage system, which is applied to the energy storage system according to claim 1, comprising:
a first battery cell replacing unit, configured to, in response to a first battery cell meeting a first exit condition, take the first battery cell out of a first battery cell compartment where the first battery cell is located, and put a second battery cell into the first battery cell compartment; wherein the first exit condition is that performance of the first battery cell is inferior to that of other battery cells in a series branch where the first battery cell compartment is located, and performance of the second battery cell is closer to that of other battery cells in the series branch where the first battery cell compartment is located than the performance of the first battery cell.

13. The apparatus according to claim 12, wherein the access channel of each of the battery cell compartments is exposed to interconnected operable sides.

14. The apparatus according to claim 13, further comprising a robot, wherein the robot is arranged at the operable side of the battery cell compartment, and the robot takes the battery cell out of the corresponding battery cell compartment after receiving a taking-out task of the battery cell or puts the battery cell into the corresponding battery cell compartment after receiving a putting-into task of the battery cell, so as to allow the battery cell access to or from the battery cell compartment where the battery cell is located.

15. The apparatus according to claim 12, wherein a plurality of battery cell compartments are connected in series to form a battery cell compartment cluster, a plurality of battery cell compartment clusters are connected in parallel, and the battery cell compartment clusters are arranged sequentially.

16. The apparatus according to claim 12, wherein at least one of the battery cell compartments is provided with a sensor to detect at least one of an environment in corresponding battery cell compartment and performance of corresponding battery cell, and the environment or performance comprises at least one of: temperature, voltage, current and internal resistance.

17. The apparatus according to claim 12, wherein the operable side is provided with a backup battery area in which a plurality of unused battery cells are stored.

18. The apparatus according to claim 12, wherein each of the battery cell compartments is provided with a bypass line, and after the battery cell compartment is disconnected from a series electrical connection with corresponding battery cell therein, the bypass line is connected between the series electrical connection points to form short-circuit.

19. An electronic device, comprising a memory, a processor and a computer program stored in the memory and executable on the processor, wherein the processor, when executing the computer program, causes the electronic device to implement the method according to claim 8.

20. A non-transitory computer-readable storage medium having a computer program stored therein, wherein the computer program, when executed on a computer, causes the computer to implement the method according to claim 8.
